(19) United States
(12) Patent Application Publication
(10) Pub. No.: US 2026/0220570 A1
(43) Pub. Date: Jul. 30, 2026

(54) MANAGEMENT SYSTEM FOR WORK SITE AND MANAGEMENT METHOD FOR WORK SITE

(71) Applicant: KOMATSU LTD., Tokyo (JP)

(72) Inventors: Seiko TAKEUCHI, Tokyo (JP); Shin NAKANO, Tokyo (JP)

(21) Appl. No.: 19/146,011

(22) PCT Filed: Jan. 12, 2024
(86) PCT No.: PCT/JP2024/000522

§ 371 Date: Jul. 7, 2025

(30) Foreign Application Priority Data
Jan. 16, 2023 (JP) 2023-004433

(51) Int. Cl. G06Q 10/0631

(52) U.S. Cl. CPC G06Q 10/06312

(57) ABSTRACT

A management system for a work site includes a processing circuit. The Processing circuit outputs a travel command to a first unmanned vehicle including a first tank so that the first unmanned vehicle travels toward a first destination while consuming liquid stored in the first tank. The Processing circuit monitors a first remaining amount of liquid stored in the first tank and a second remaining amount of liquid stored in a second tank included in a second unmanned vehicle. The Processing circuit outputs a travel command to the second unmanned vehicle so that the second unmanned vehicle travels toward the first destination in a case in which an assignment change condition is determined to be satisfied that the first remaining amount is equal to or less than a predetermined threshold and oil sufficient for the second remaining amount to travel toward the first destination is stored.

### CROSS-REFERENCE TO RELATED APPLICATIONS

This application is a U.S. National stage application of International Application No. PCT/JP2024/000522, filed on Jan. 12, 2024. This U.S. National stage application claims priority under 35 U.S.C. § 119(a) to Japanese Patent Application No. 2023-004433, filed in Japan on Jan. 16, 2023. The entire contents of Japanese Patent Application No. 2023-004433 is hereby incorporated herein by reference.

### BACKGROUND

### Technical Field

The present disclosure relates to a management system for a work site and a management method for a work site.

### Background Art

An unmanned vehicle may operate at a work site. For example, as disclosed in US 2011/0288769 A, an unmanned transport vehicle and an unmanned sprinkling vehicle may operate as an unmanned vehicle.

### SUMMARY

In a case where the power source of an unmanned vehicle is an engine, the unmanned vehicle travels toward a destination while consuming fuel. If the fuel runs out before the unmanned vehicle arrives at the destination, the unmanned vehicle is stuck on a traveling road, and a work purpose cannot be achieved. Furthermore, a stuck truck may block a traveling road and a following truck cannot travel, or the following truck may go out of a course when avoiding the stuck truck. If the work purpose of the unmanned vehicle is not achieved from the above events, the productivity at the work site may be decreased.

An object of the present disclosure is to reduce a decrease in productivity at a work site.

According to the present disclosure, provided is a management system for a work site including: an assignment unit that outputs a travel command to a first unmanned vehicle including a first tank so that the first unmanned vehicle travels toward a first destination of a work site while consuming liquid stored in the first tank; and a remaining amount management unit that monitors a first remaining amount indicating a remaining amount of liquid stored in the first tank and a second remaining amount indicating a remaining amount of liquid stored in a second tank included in a second unmanned vehicle. The assignment unit outputs a travel command to the second unmanned vehicle so that the second unmanned vehicle travels toward the first destination in a case where an assignment change condition is determined to be satisfied that the first remaining amount is equal to or less than a predetermined threshold and the second remaining amount exceeds the first remaining amount.

According to the present disclosure, a decrease in productivity at a work site is reduced.

### BRIEF DESCRIPTION OF DRAWINGS

Referring now to the attached drawings which form a part of this original disclosure, an illustrative embodiment is shown.

FIG. 1 is a schematic diagram illustrating a management system for a work site according to an embodiment.

FIG. 2 is a configuration diagram illustrating the work site according to the embodiment.

FIG. 3 is a functional block diagram illustrating the management system for the work site according to the embodiment.

FIG. 4 is a diagram for describing travel data of an unmanned transport vehicle according to the embodiment.

FIG. 5 is a schematic diagram illustrating a management method for the unmanned transport vehicle according to the embodiment.

FIG. 6 is a schematic diagram illustrating the management method for the unmanned transport vehicle according to the embodiment.

FIG. 7 is a schematic diagram illustrating the management method for the unmanned transport vehicle according to the embodiment.

FIG. 8 is a flowchart illustrating the management method for the unmanned transport vehicle according to the embodiment.

FIG. 9 is a schematic diagram illustrating a management method for the unmanned sprinkling vehicle according to the embodiment.

FIG. 10 is a schematic diagram illustrating the management method for the unmanned sprinkling vehicle according to the embodiment.

FIG. 11 is a flowchart illustrating the management method for the unmanned sprinkling vehicle according to the embodiment.

### DETAILED DESCRIPTION OF EMBODIMENT(S)

Hereinafter, embodiments according to the present disclosure will be described with reference to the drawings, but the present disclosure is not limited to the embodiments. Components of the embodiments described below can be appropriately combined. Furthermore, some components may not be used.

### (Outline of Management System)

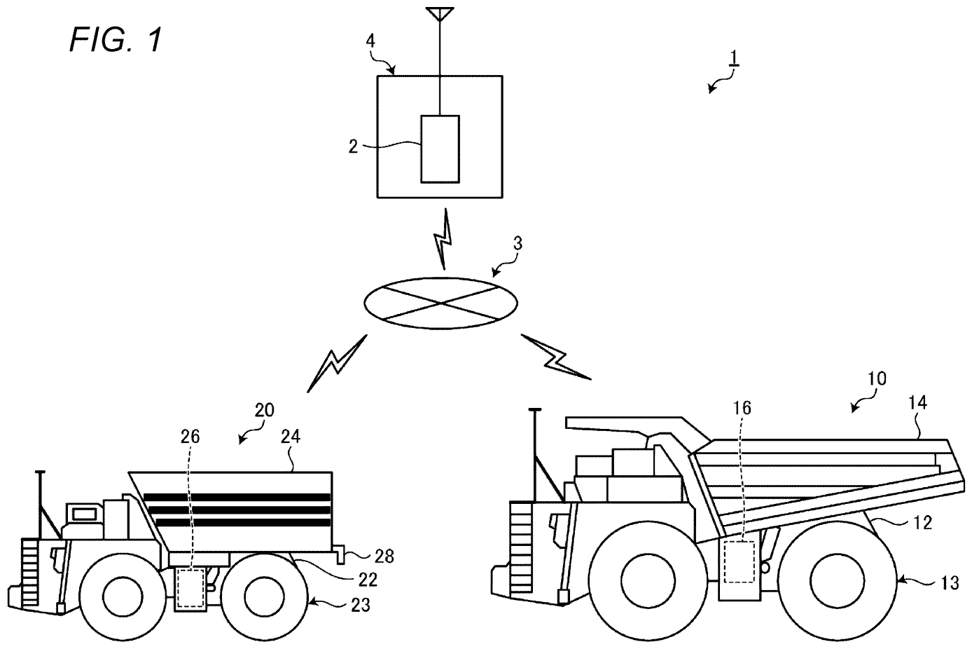

FIG. 1 is a schematic diagram illustrating a management system 1 for a work site according to an embodiment. The management system 1 manages all unmanned vehicles including the management system that operate at the work site and a loading vehicle. An unmanned vehicle refers to a work vehicle that operates in an unmanned manner without depending on a driving operation by a driver. Furthermore, the management system 1 manages vehicle statuses of an unmanned vehicle and a loading vehicle to be managed. In the embodiment, the unmanned vehicles that operate at the work site include an unmanned transport vehicle 10 and an unmanned sprinkling vehicle 20. The unmanned transport vehicle 10 travels in an unmanned manner at a work site so as to transport a load. An unmanned dump truck is exemplified as the unmanned transport vehicle 10. As a load to be transported by the unmanned transport vehicle 10, an excavated object excavated at the work site is exemplified. The unmanned sprinkling vehicle 20 travels in the work site in an unmanned manner so as to sprinkle water. An unmanned sprinkling truck is exemplified as the unmanned sprinkling vehicle 20. The unmanned sprinkling vehicle 20 sprinkles water so as to reduce diffusion of dust or sand at the work site.

The management system 1 includes a management device 2 and a communication system 3. The management device 2 is installed in a control facility 4 at the work site. There is an administrator in the control facility 4. The management device 2, the unmanned transport vehicle 10, and the unmanned sprinkling vehicle 20 wirelessly communicate with each other via the communication system 3. Examples of the communication system 3 include the Internet, a mobile phone communication network, a satellite communication network, and a local area network (LAN).

The unmanned transport vehicle 10 includes a vehicle body 12, a traveling device 13, a dump body 14, and a tank 16. The vehicle body 12 includes a vehicle body frame. The vehicle body 12 is supported by the traveling device 13. The vehicle body 12 supports the dump body 14. The traveling device 13 travels at the work site while supporting the vehicle body 12. The traveling device 13 includes wheels, tires attached to the wheels, an engine, a brake device, and a steering device. The engine generates a driving force for causing the unmanned transport vehicle 10 to travel. As the tires rotate, the unmanned transport vehicle 10 travels. The brake device generates a braking force for decelerating or stopping the unmanned transport vehicle 10. The steering device generates a steering force for turning the unmanned transport vehicle 10. The dump body 14 is a member on which a load is loaded. At least a part of the dump body 14 is disposed above the vehicle body 12. The tank 16 stores oil that is fuel for the engine of the traveling device 13. By the oil being burned in the engine, a driving force for traveling of the unmanned transport vehicle 10 is generated.

The unmanned sprinkling vehicle 20 includes a vehicle body 22, a traveling device 23, a tank 24, a tank 26, and a sprinkling spray 28. The vehicle body 22 includes a vehicle body frame. The vehicle body 22 is supported by the traveling device 23. The vehicle body 22 supports the tank 24. The traveling device 23 travels at the work site while supporting the vehicle body 22. The traveling device 23 includes wheels, tires attached to the wheels, an engine, a brake device, and a steering device. The engine generates a driving force for causing the unmanned sprinkling vehicle 20 to travel. As the tires rotate, the unmanned sprinkling vehicle 20 travels. The brake device generates a braking force for decelerating or stopping the unmanned sprinkling vehicle 20. The steering device generates a steering force for turning the unmanned sprinkling vehicle 20. The tank 24 is a member that stores water for sprinkling. At least a part of the tank 24 is disposed above the vehicle body 22. The tank 26 stores oil that is fuel for the engine of the traveling device 23. By the oil being burned in the engine, a driving force for traveling of the unmanned sprinkling vehicle 20 is generated. The sprinkling spray 28 sprinkles water in the tank 24. The sprinkling spray 28 is disposed at the rear of the tank 24. The sprinkling spray 28 sprinkles water behind the unmanned sprinkling vehicle 20.

### (Work Site)

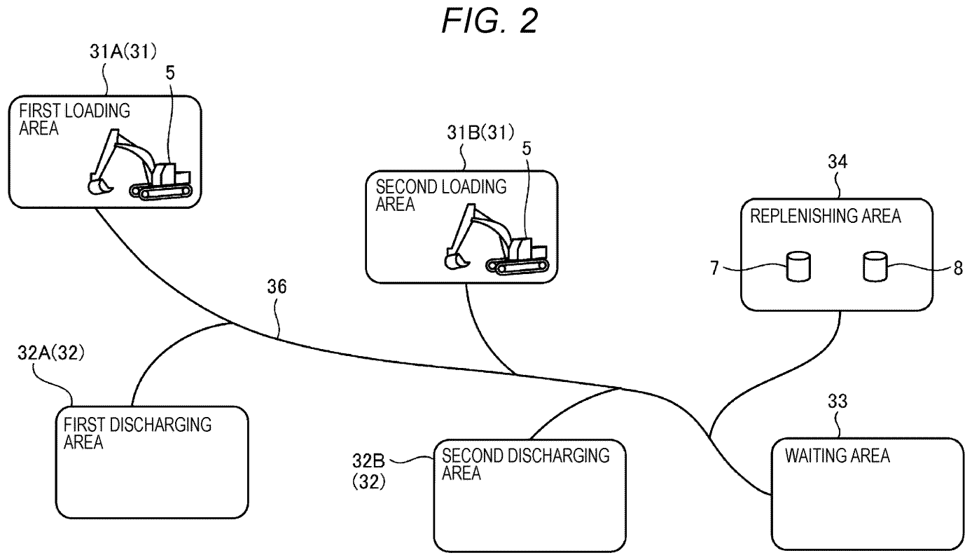

FIG. 2 is a configuration diagram illustrating the work site according to the embodiment. Examples of the work site include a mine or a quarry. The mine refers to a place or a business site where minerals are mined. As the mine, a metal mine where metal is mined, a non-metal mine where limestone is mined, and a coal mine where coal is mined are exemplified. A quarry refers to a place or business site where stones are mined. At the work site, each of the unmanned transport vehicle 10 and the unmanned sprinkling vehicle 20 operates. At the work site, there are a plurality of unmanned transport vehicles 10 having different vehicle statuses, an unmanned sprinkling vehicle 20, and a loader 5.

A loading area 31, a discharging area 32, a waiting area 33, a replenishing area 34, and a traveling path 36 are included in the work site. The loading area 31 refers to an area where loading work is performed in which the loader 5 loads a load onto the unmanned transport vehicle 10. The loader 5 operates in the loading area 31. As the loader 5, an excavator is exemplified. In the embodiment, the loading area 31 includes a first loading area 31A and a second loading area 31B. The discharging area 32 is an area in which discharging work is performed in which a load is discharged by the unmanned transport vehicle 10. In the embodiment, the discharging area 32 includes a first discharging area 32A and a second discharging area 32B. In the present embodiment, the first loading area 31A and the first discharging area 32A are set as areas having high work priority. The waiting area 33 is an area where at least one of the unmanned transport vehicle 10 or the unmanned sprinkling vehicle 20 waits (is parked). The replenishing area 34 is an area where each of the unmanned transport vehicle 10 and the unmanned sprinkling vehicle 20 is supplied with fuel and the unmanned sprinkling vehicle 20 is supplied with water. An oil feeder 7 that supplies oil is included in the replenishing area 34. In the replenishing area 34, oil that is fuel of the engine is supplied to the tank 16 of the unmanned transport vehicle 10 or the tank 26 of the unmanned sprinkling vehicle 20. Furthermore, a water supply device 8 that supplies water is included in the replenishing area 34. In the replenishing area 34, sprinkled water is supplied to the tank 24 of the unmanned sprinkling vehicle 20. The traveling path 36 is an area where an unmanned vehicle travels toward at least one of the loading area 31, the discharging area 32, the waiting area 33, or the replenishing area 34. The traveling path 36 is included so as to connect at least the loading area 31 and the discharging area 32. In the embodiment, the traveling path 36 is connected to each of the loading area 31, the discharging area 32, the waiting area 33, and the replenishing area 34.

### (Management System)

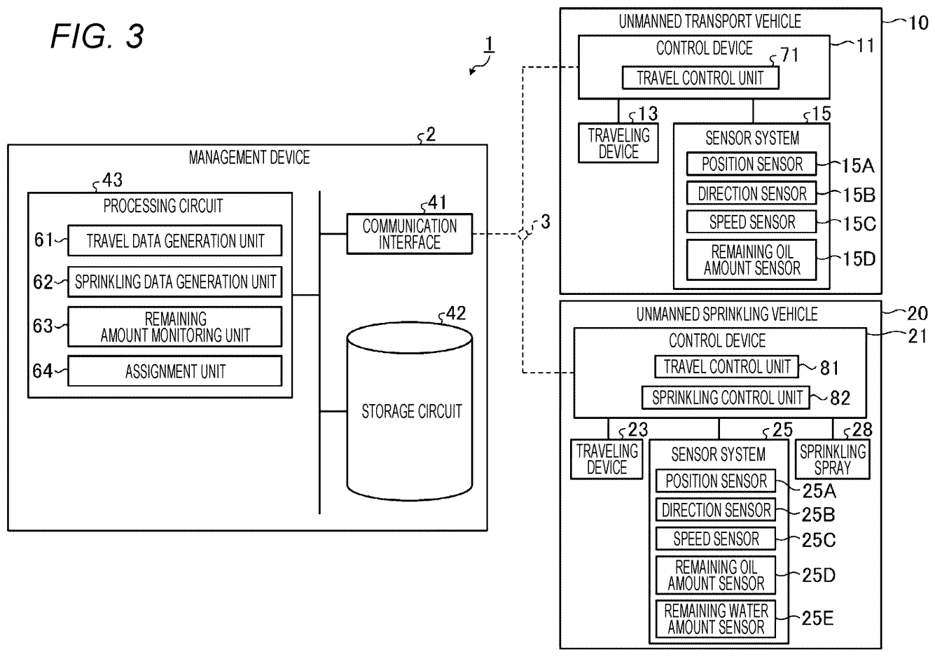

FIG. 3 is a functional block diagram illustrating the management system 1 for the work site according to the embodiment. The unmanned transport vehicle 10 includes a control device 11, the traveling device 13, and a sensor system 15. The unmanned sprinkling vehicle 20 includes a control device 21, the traveling device 23, a sensor system 25, and the sprinkling spray 28.

The sensor system 15 includes a position sensor 15A, a direction sensor 15B, a speed sensor 15C, and a remaining oil amount sensor 15D. The position sensor 15A detects the position of the unmanned transport vehicle 10. The position of the unmanned transport vehicle 10 is detected using a global navigation satellite system (GNSS). The global navigation satellite system includes a global positioning system (GPS). The global navigation satellite system detects a position in a global coordinate system defined by coordinate data of latitude, longitude, and altitude. The global coordinate system refers to a coordinate system fixed to the earth. The position sensor 15A includes a GNSS receiver and detects the position of the unmanned transport vehicle 10 in the global coordinate system. The direction sensor 15B detects the direction of the unmanned transport vehicle 10. As the direction sensor 15B, a gyro sensor is exemplified. The speed sensor 15C detects a traveling speed of the unmanned transport vehicle 10. As the speed sensor 15C, a pulse sensor that detects rotation of wheels is exemplified. The remaining oil amount sensor 15D detects the remaining amount of oil stored in the tank 16 of the unmanned transport vehicle 10. The remaining oil amount sensor 15D may be a weight sensor that detects the weight of the oil stored in the tank 16 or a liquid level sensor that detects the height of the surface of the oil stored in the tank 16.

The sensor system 25 includes a position sensor 25A, a direction sensor 25B, a speed sensor 25C, a remaining oil amount sensor 25D, and a remaining water amount sensor 25E. The position sensor 25A detects the position of the unmanned sprinkling vehicle 20. The position sensor 25A includes a GNSS receiver and detects the position of the unmanned sprinkling vehicle 20 in the global coordinate system. The direction sensor 25B detects the direction of the unmanned sprinkling vehicle 20. As the direction sensor 25B, a gyro sensor is exemplified. The speed sensor 25C detects a traveling speed of the unmanned sprinkling vehicle 20. As the speed sensor 25C, a pulse sensor that detects rotation of wheels is exemplified. The remaining oil amount sensor 25D detects the remaining amount of oil stored in the tank 26 of the unmanned sprinkling vehicle 20. The remaining oil amount sensor 25D may be a weight sensor that detects the weight of the oil stored in the tank 26 or a liquid level sensor that detects the height of the surface of the oil stored in the tank 26. The remaining water amount sensor 25E detects the remaining amount of water stored in the tank 24 of the unmanned sprinkling vehicle 20. The remaining water amount sensor 25E may be a weight sensor that detects the weight of the water stored in the tank 24 or a liquid level sensor that detects the height of the surface of the water stored in the tank 24.

The management system 1 includes the management device 2, the communication system 3, the control device 11, and the control device 21. The management device 2 includes a computer system. The management device 2 includes a communication interface 41, a storage circuit 42, and a processing circuit 43. The communication interface 41 is connected to the processing circuit 43. The communication interface 41 controls communication between the management device 2 and at least one of the control device 11 or the control device 21. The communication interface 41 communicates with at least one of the control device 11 or the control device 21 via the communication system 3.

The storage circuit 42 is connected to the processing circuit 43. The storage circuit 42 stores data. As the storage circuit 42, a nonvolatile memory or a volatile memory is exemplified. As the nonvolatile memory, a read only memory (ROM) or a storage is exemplified. As the storage, a hard disk drive (HDD) or a solid state drive (SSD) is exemplified. As the volatile memory, a random access memory (RAM) is exemplified.

The processing circuit 43 performs arithmetic processing and control command output processing. As the processing circuit 43, a processor is exemplified. As the processor, a central processing unit (CPU) or a micro processing unit (MPU) is exemplified. A computer program is stored in the storage circuit 42. The processing circuit 43 exerts a predetermined function by acquiring and executing the computer program from the storage circuit 42.

The processing circuit 43 includes a travel data generation unit 61, a sprinkling data generation unit 62, a remaining amount monitoring unit 63, and an assignment unit 64.

The travel data generation unit 61 generates travel data indicating travel conditions of each of the unmanned transport vehicle 10 and the unmanned sprinkling vehicle 20 set for a work site. The travel conditions include a travel path indicating a target travel route.

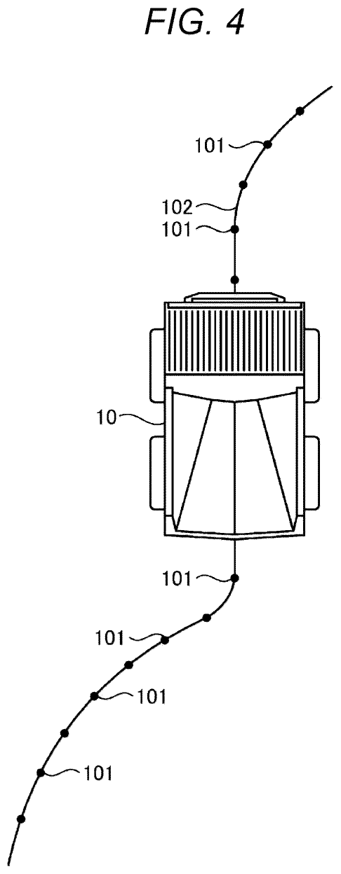

FIG. 4 is a diagram for describing travel data of the unmanned transport vehicle 10 according to the embodiment. The travel data of the unmanned transport vehicle 10 defines travel conditions of the unmanned transport vehicle 10. The travel data includes course points 101, a travel path 102, a target position of the unmanned transport vehicle 10, a target direction of the unmanned transport vehicle 10, and a target travel speed of the unmanned transport vehicle 10. A plurality of course points 101 is set at the work site. Each of the course points 101 defines a target position of the unmanned transport vehicle 10. A target direction and a target travel speed of the unmanned transport vehicle 10 are set for each of the plurality of course points 101. The plurality of course points 101 is set at intervals. The intervals between the course points 101 are set to, for example, 1 [m] or more and 5 [m] or less. The intervals between the course points 101 may be uniform or non-uniform. The travel path 102 refers to a virtual line indicating a target travel route of the unmanned transport vehicle 10. The travel path 102 is defined by a trajectory passing through the plurality of course points 101. The unmanned transport vehicle 10 travels at the work site according to the travel path 102. The target position of the unmanned transport vehicle 10 refers to a target position of the unmanned transport vehicle 10 when passing through the course point 101. The target position of the unmanned transport vehicle 10 may be defined in a local coordinate system of the unmanned transport vehicle 10 or may be defined in a global coordinate system. The target direction of the unmanned transport vehicle 10 refers to a target direction of the unmanned transport vehicle 10 when passing through the course point 101. The target travel speed of the unmanned transport vehicle 10 refers to a target travel speed of the unmanned transport vehicle 10 when passing through the course point 101. Similarly to the travel data of the unmanned transport vehicle 10, travel data that defines the travel conditions of the unmanned sprinkling vehicle 20 is generated. The travel data generated by the travel data generation unit 61 is transmitted to each of the unmanned transport vehicle 10 and the unmanned sprinkling vehicle 20 via the communication system 3.

The sprinkling data generation unit 62 sets sprinkling data for controlling the sprinkling spray 28. The sprinkling data set by the sprinkling data generation unit 62 includes execution and stop of sprinkling from the sprinkling spray 28. The sprinkling data set by the sprinkling data generation unit 62 includes a sprinkling amount from the sprinkling spray 28. In a case where a plurality of sprinkling sprays 28 is included in the unmanned sprinkling vehicle 20, the sprinkling data set by the sprinkling data generation unit 62 includes the number of sprinkling sprays 28 that execute sprinkling. In a case where sprinkling sprays 28 are installed at a plurality of respective positions of the unmanned sprinkling vehicle 20, the sprinkling data set by the sprinkling data generation unit 62 includes installation positions of the sprinkling sprays 28 that execute sprinkling. Furthermore, the sprinkling data set by the sprinkling data generation unit 62 includes a sprinkling area where sprinkling is performed at the work site. The sprinkling area refers to an area on which sprinkling from the sprinkling spray 28 of the unmanned sprinkling vehicle 20 is performed at the work site. The travel data generated by the sprinkling data generation unit 62 is transmitted to the unmanned sprinkling vehicle 20 via the communication system 3.

The remaining amount monitoring unit 63 monitors the remaining amount of oil stored in the tank 16, the remaining amount of oil stored in the tank 26, and the remaining amount of water stored in the tank 24. Detection data of the remaining oil amount sensor 15D, detection data of the remaining oil amount sensor 25D, and detection data of the remaining water amount sensor 25E are transmitted to the management device 2 via the communication system 3. The remaining amount monitoring unit 63 can monitor the remaining amount of oil stored in the tank 16 on the basis of the detection data of the remaining oil amount sensor 15D. The remaining amount monitoring unit 63 can monitor the remaining amount of oil stored in the tank 26 on the basis of the detection data of the remaining oil amount sensor 25D. The remaining amount monitoring unit 63 can monitor the remaining amount of water stored in the tank 24 on the basis of the detection data of the remaining water amount sensor 25E.

The assignment unit 64 outputs a travel command to each of the unmanned transport vehicle 10 and the unmanned sprinkling vehicle 20 so that the unmanned transport vehicle 10 and the unmanned sprinkling vehicle 20 travel toward the destination of the work site. The assignment unit 64 may automatically perform assignment or change assignment by the management device 2, or may perform assignment or change assignment by the administrator of the control facility 4. For example, in a case where the unmanned transport vehicle 10 is caused to travel toward the first loading area 31A, the assignment unit 64 outputs a travel command to the unmanned transport vehicle 10 so that the unmanned transport vehicle 10 travels toward the first loading area 31A as a destination. For example, in a case where the unmanned sprinkling vehicle 20 is caused to travel toward the first discharging area 32A, the assignment unit 64 outputs a travel command to the unmanned sprinkling vehicle 20 so that the unmanned sprinkling vehicle 20 travels toward the first discharging area 32A as a destination. The travel command output by the assignment unit 64 is transmitted to each of the unmanned transport vehicle 10 and the unmanned sprinkling vehicle 20 via the communication system 3.

The control device 11 includes a computer system. Similarly to the management device 2, the control device 11 includes a communication interface, a storage circuit, and a processing circuit. The control device 11 includes a travel control unit 71 that controls the traveling device 13. The travel control unit 71 controls the traveling device 13 on the basis of the travel data transmitted from the management device 2.

The control device 21 includes a computer system. Similarly to the management device 2, the control device 21 includes a communication interface, a storage circuit, and a processing circuit. The control device 21 includes a travel control unit 81 that controls the traveling device 23 and a sprinkling control unit 82 that controls the sprinkling spray 28. The travel control unit 81 controls the traveling device 23 on the basis of the travel data transmitted from the management device 2. The sprinkling control unit 82 controls the sprinkling spray 28 on the basis of the sprinkling data transmitted from the management device 2.

The travel control unit 71 controls the traveling device 13 on the basis of the travel data and the detection data of the sensor system 15. The travel control unit 71 controls the traveling device 13 such that the unmanned transport vehicle 10 travels on the basis of the travel path 102 on the basis of the detection data of the position sensor 15A and the detection data of the direction sensor 15B. That is, the travel control unit 71 controls the traveling device 13 so as to reduce a deviation between the detection position of the unmanned transport vehicle 10 detected by the position sensor 15A when the unmanned transport vehicle 10 passes through the course point 101 and the target position of the unmanned transport vehicle 10 set at the course point 101.

Furthermore, the travel control unit 71 controls the traveling device 13 so as to reduce a deviation between the detection direction of the unmanned transport vehicle 10 detected by the direction sensor 15B when the unmanned transport vehicle 10 passes through the course point 101 and the target direction of the unmanned transport vehicle 10 set at the course point 101. Furthermore, the travel control unit 71 controls the traveling device 13 such that the unmanned transport vehicle 10 travels at the target travel speed on the basis of the detection data of the speed sensor 15C. That is, the travel control unit 71 controls the traveling device 13 so as to reduce a deviation between the detection travel speed of the unmanned transport vehicle 10 detected by the speed sensor 15C when the unmanned transport vehicle 10 passes through the course point 101 and the target travel speed of the unmanned transport vehicle 10 set at the course point 101.

The travel control unit 81 controls the traveling device 23 on the basis of the travel data and the detection data of the sensor system 25. The travel control unit 81 controls the traveling device 23 such that the unmanned sprinkling vehicle 20 travels on the basis of the travel path 102 on the basis of the detection data of the position sensor 25A and the detection data of the direction sensor 25B. Furthermore, the travel control unit 81 controls the traveling device 23 such that the unmanned sprinkling vehicle 20 travels at the target travel speed on the basis of the detection data of the speed sensor 25C.

### (Management Method for Unmanned Transport Vehicle)

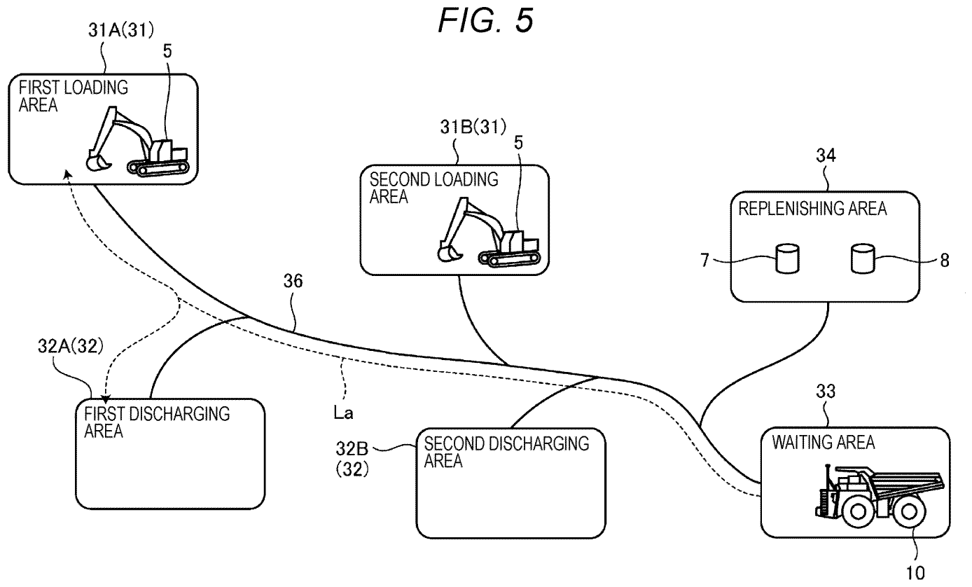

Each of FIGS. 5, 6, and 7 is a schematic diagram illustrating the management method for the unmanned transport vehicle 10 according to the embodiment. As illustrated in FIG. 5, for example, in a case where the unmanned transport vehicle 10 is caused to travel toward the first loading area 31A, the assignment unit 64 outputs a travel command to the unmanned transport vehicle 10 via the communication interface 41 so that the unmanned transport vehicle 10 travels toward the first loading area 31A as a destination. The unmanned transport vehicle 10 travels toward the first loading area 31A on the basis of the travel data. In the example illustrated in FIG. 5, the unmanned transport vehicle 10 travels from the waiting area 33 toward the first loading area 31A. When the unmanned transport vehicle 10 travels, oil stored in the tank 16 is burned in the engine, and the oil in the tank 16 is consumed. The unmanned transport vehicle 10 travels toward the first loading area 31A of the work site while consuming the oil stored in the tank 16. If sufficient oil is stored in the tank 16, the unmanned transport vehicle 10 can travel to the first loading area 31A, for example, as illustrated by a line La in FIG. 5.

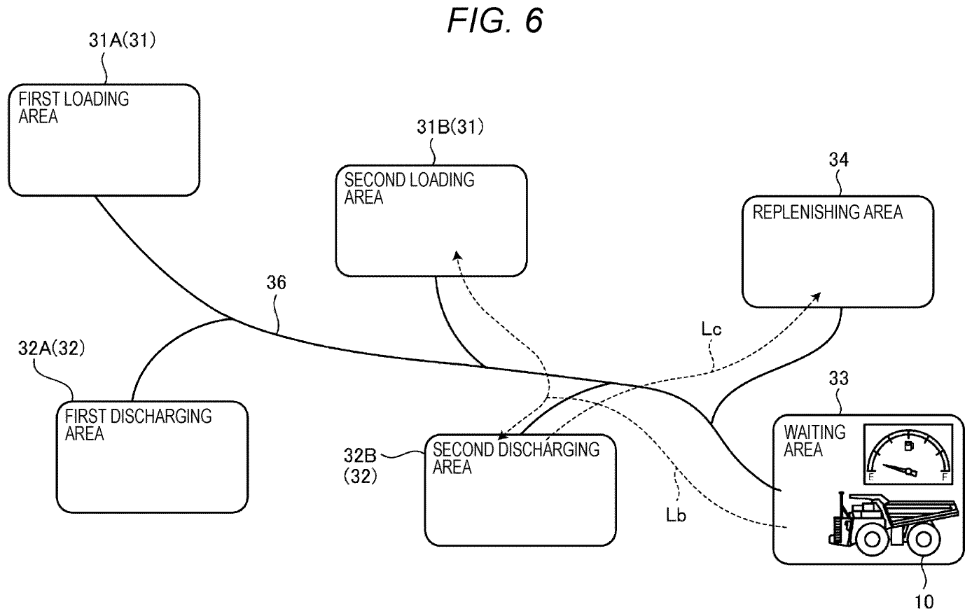

If the amount of oil stored in the tank 16 is small, the unmanned transport vehicle 10 may have difficulty in traveling to the first loading area 31A. The remaining amount monitoring unit 63 monitors the remaining amount of oil stored in the tank 16 of the unmanned transport vehicle 10. As illustrated in FIG. 6, if it is determined that the remaining amount of the oil stored in the tank 16 is equal to or less than a predetermined threshold and oil sufficient for the remaining amount of the oil stored in the tank 16 to travel toward the second loading area 31B is stored, the assignment unit 64 outputs a travel command to the unmanned transport vehicle 10 so that the unmanned transport vehicle 10 travels toward the second loading area 31B closer to the unmanned transport vehicle 10 than the first loading area 31A. That is, if it is determined that the remaining amount of the oil in the tank 16 is small and sufficient oil for traveling toward the second loading area 31B is stored, the assignment unit 64 changes the destination of the unmanned transport vehicle 10 from the first loading area 31A to the second loading area 31B. In other words, the assignment unit 64 assigns the unmanned transport vehicle 10 assigned to the first loading area 31A to the second loading area 31B. The current position of the unmanned transport vehicle 10 detected by the position sensor 15A is transmitted to the management device 2 via the communication system 3. If it is determined that the remaining amount of the oil stored in the tank 16 is equal to or less than the predetermined threshold, the assignment unit 64 can change the destination of the unmanned transport vehicle 10 from the first loading area 31A to the second loading area 31B on the basis of the position of the first loading area 31A and the position of the second loading area 31B that are known data, and the current position of the unmanned transport vehicle 10 detected by the position sensor 15A. Note that the assignment unit 64 may change the destination of the unmanned transport vehicle 10 from the first loading area 31A to the second loading area 31B on the basis of the length of the travel path 102 from the current position of the unmanned transport vehicle 10 to the first loading area 31A and the length of the travel path 102 from the current position of the unmanned transport vehicle 10 to the second loading area 31B that are generated by the travel data generation unit 61. If the amount of the oil stored in the tank 16 is small, the unmanned transport vehicle 10 travels to the second loading area 31B so as to load a load, and then travels to the second discharging area 32B so as to discharge the load, for example, as indicated by a line Lb in FIG. 6. Furthermore, the unmanned transport vehicle 10 that has discharged the load in the second discharging area 32B travels toward the replenishing area 34, for example, as indicated by a line Lc in FIG. 6. In the replenishing area 34, oil is supplied to the tank 16 of the unmanned transport vehicle 10. Note that, if the remaining amount of the oil stored in the tank 16 is small, the unmanned transport vehicle 10 may travel from the current position toward the replenishing area 34.

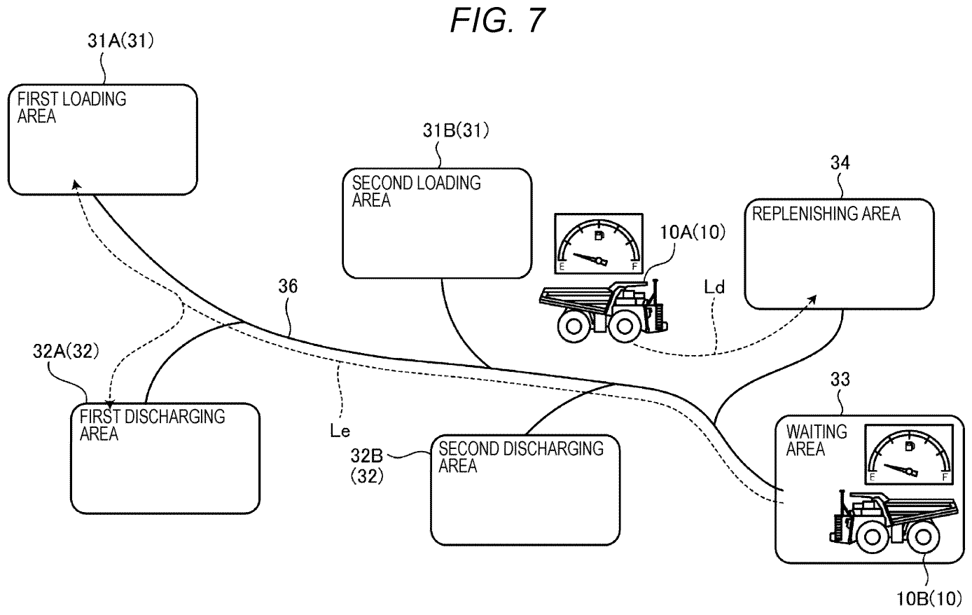

As illustrated in FIG. 7, if a first unmanned transport vehicle 10A (first unmanned vehicle) and a second unmanned transport vehicle 10B (second unmanned vehicle) are present at the work site, the remaining amount monitoring unit 63 monitors a first remaining amount indicating the remaining amount of oil stored in the tank 16 of the first unmanned transport vehicle 10A and a second remaining amount indicating the remaining amount of oil stored in the tank 16 included in the second unmanned transport vehicle 10B. In a case where the first unmanned transport vehicle 10A is traveling toward the first loading area 31A (first destination), if it is determined that an assignment change condition is satisfied that the first remaining amount indicating the remaining amount of the oil stored in the tank 16 of the first unmanned transport vehicle 10A is equal to or less than a predetermined threshold, the second remaining amount indicating the remaining amount of the oil stored in the tank 16 of the second unmanned transport vehicle 10B exceeds the first remaining amount, and sufficient oil for the second unmanned transport vehicle 10B to travel toward the first loading area 31A is stored, the assignment unit 64 outputs a travel command to the second unmanned transport vehicle 10B so that the second unmanned transport vehicle 10B travels toward the first loading area 31A (first destination).

Furthermore, if it is determined that the assignment change condition is satisfied, the assignment unit 64 outputs a travel command to the first unmanned transport vehicle 10A so that the first unmanned transport vehicle 10A travels toward the second loading area 31B (second destination) closer to the first unmanned transport vehicle 10A than the first loading area 31A (first destination). Note that, if it is determined that the assignment change condition is satisfied and sufficient oil for traveling toward the second loading area 31B is not stored, the assignment unit 64 may output a travel command to the first unmanned transport vehicle 10A so that the first unmanned transport vehicle 10A travels toward the replenishing area 34 (second destination) closer to the first unmanned transport vehicle 10A than the first loading area 31A (first destination). In the replenishing area 34, oil is supplied to the tank 16 of the first unmanned transport vehicle 10A.

That is, if the remaining amount of the oil stored in the tank 16 of the first unmanned transport vehicle 10A is small and there is the second unmanned transport vehicle 10B including the tank 16 in which sufficient oil is stored, the assignment unit 64 assigns the second unmanned transport vehicle 10B to the first loading area 31A and assigns the first unmanned transport vehicle 10A assigned to the first loading area 31A to the second loading area 31B or the replenishing area 34.

For example, the assignment unit 64 may assign the second unmanned transport vehicle 10B assigned to the second loading area 31B to the first loading area 31A, or may assign the second unmanned transport vehicle 10B waiting in the waiting area 33 to the first loading area 31A. That is, if it is determined that the assignment change condition is satisfied, the assignment unit 64 may output a travel command to the second unmanned transport vehicle 10B so that the second unmanned transport vehicle 10B traveling toward the second loading area 31B (second destination) travels toward the first loading area 31A (first destination), and output a travel command to the first unmanned transport vehicle 10A so that the first unmanned transport vehicle 10A traveling toward the first loading area 31A (first destination) travels toward the second loading area 31B (second destination). That is, if it is determined that the assignment change condition is satisfied, the assignment unit 64 may switch the destination of the first unmanned transport vehicle 10A and the destination of the second unmanned transport vehicle 10B. Furthermore, if it is determined that the assignment change condition is satisfied, the assignment unit 64 may output a travel command to the second unmanned transport vehicle 10B so that the second unmanned transport vehicle 10B waiting in the waiting area 33 travels toward the first loading area 31A (first destination), and output a travel command to the first unmanned transport vehicle 10A so that the first unmanned transport vehicle 10A traveling toward the first loading area 31A (first destination) travels toward the replenishing area 34 (second destination).

In the example illustrated in FIG. 7, if it is determined that the assignment change condition is satisfied, the second unmanned transport vehicle 10B waiting in the waiting area 33 travels toward the first loading area 31A as indicated by a line Le, and the first unmanned transport vehicle 10A travels from the current position toward the replenishing area 34 as indicated by a line Ld.

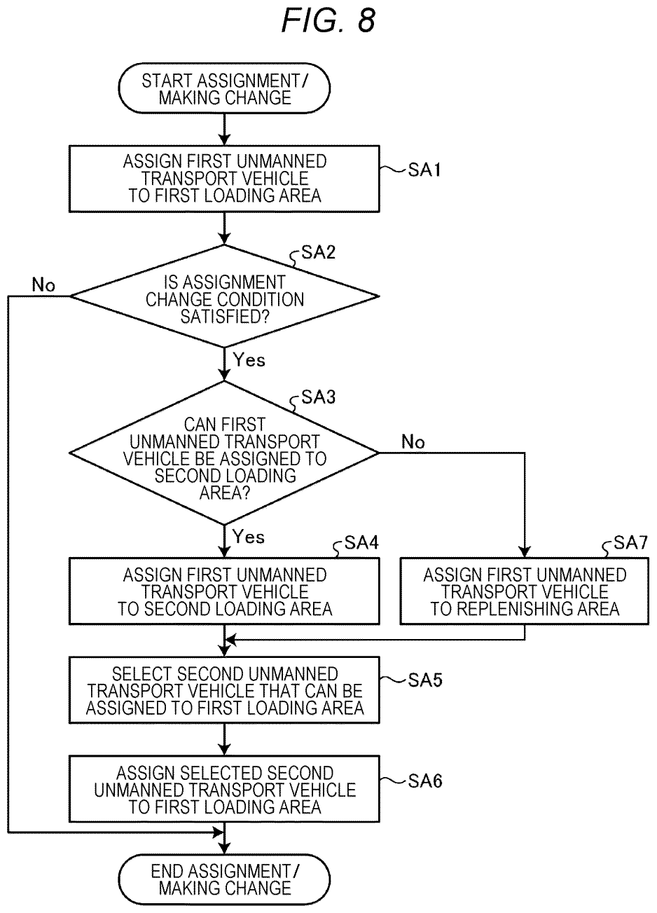

FIG. 8 is a flowchart illustrating the management method for the unmanned transport vehicle 10 according to the embodiment. As a flow start condition, the management device 2 or the administrator of the control facility 4 starts to assign the first unmanned transport vehicle 10A to the first loading area 31A or make a change. The assignment unit 64 assigns the first unmanned transport vehicle 10A to the first loading area 31A (step SA1). The first remaining amount indicating the remaining amount of the oil stored in the tank 16 of the first unmanned transport vehicle 10A and the second remaining amount indicating the remaining amount of the oil stored in the tank 16 included in the second unmanned transport vehicle 10B are monitored by the remaining amount monitoring unit 63. The assignment unit 64 determines whether the assignment change condition is satisfied that the first remaining amount is equal to or less than a predetermined threshold and the second remaining amount exceeds the first remaining amount (step SA2).

In step SA2, if it is determined that the assignment change condition is satisfied (step SA2: Yes), the assignment unit 64 determines whether the first unmanned transport vehicle 10A can be assigned to the second loading area 31B (step SA3). That is, the assignment unit 64 determines whether the first unmanned transport vehicle 10A can travel from the current position to the second loading area 31B on the basis of the first remaining amount and the fuel consumption of the first unmanned transport vehicle 10A. That is, the assignment unit 64 determines whether oil sufficient for the first unmanned transport vehicle 10A to travel from the current position to the second loading area 31B remains in the tank 16.

In step SA3, if it is determined that the first unmanned transport vehicle 10A can be assigned to the second loading area 31B (step SA3: Yes), the assignment unit 64 assigns the first unmanned transport vehicle 10A to the second loading area 31B (step SA4). The destination of the first unmanned transport vehicle 10A is changed from the first loading area 31A to the second loading area 31B. The first unmanned transport vehicle 10A travels toward the second loading area 31B.

In a case where there is a plurality of second unmanned transport vehicles 10B in which sufficient oil is stored in the tank 16, the assignment unit 64 selects the second unmanned transport vehicle 10B that can be assigned to the first loading area 31A (step SA5). The assignment unit 64 may select the second unmanned transport vehicle 10B closest to the first loading area 31A among the plurality of second unmanned transport vehicles 10B. That is, the assignment unit 64 may select the second unmanned transport vehicle 10B having the shortest travel distance to the first loading area 31A on the basis of the current position of each of the plurality of second unmanned transport vehicles 10B and the position of the first loading area 31A. In a case where there is a plurality of second unmanned transport vehicles 10B having different vehicle statuses, the second unmanned transport vehicle 10B that matches a loader of the assignment destination may be selected. The assignment unit 64 assigns the selected second unmanned transport vehicle 10B to the first loading area 31A (step SA6). The selected second unmanned transport vehicle 10B travels toward the first loading area 31A.

In step SA3, if it is determined that the first unmanned transport vehicle 10A cannot be assigned to the second loading area 31B (step SA3: No), the assignment unit 64 assigns the first unmanned transport vehicle 10A to the replenishing area 34 (step SA7). The destination of the first unmanned transport vehicle 10A is changed from the first loading area 31A to the replenishing area 34. The first unmanned transport vehicle 10A travels toward the replenishing area 34.

The unmanned transport vehicle 10 has been described above. The description similarly applies to the unmanned sprinkling vehicle 20. When a first unmanned sprinkling vehicle 20A is traveling toward the first destination while consuming the oil stored in the tank 26 by the engine, if it is determined that the assignment change condition is satisfied that the first remaining amount indicating the remaining amount of the oil stored in the tank 26 of the first unmanned sprinkling vehicle 20A is equal to or less than a threshold and the second remaining amount indicating the remaining amount of the oil stored in the tank 26 of a second unmanned sprinkling vehicle 20B exceeds the first remaining amount, the destination of the first unmanned sprinkling vehicle 20A may be changed from the first destination to the second destination, and the second unmanned sprinkling vehicle 20B may be assigned to the first destination. The first destination of the unmanned sprinkling vehicle 20 may be a first sprinkling area where sprinkling work set by the sprinkling data generation unit 62 is performed. The second destination of the unmanned sprinkling vehicle 20 may be a second sprinkling area where sprinkling work set by the sprinkling data generation unit 62 is performed. The second destination of the unmanned sprinkling vehicle 20 may be the replenishing area 34 for replenishing the tank 26 of the first unmanned sprinkling vehicle 20A with oil.

### (Management Method for Unmanned Sprinkling Vehicle)

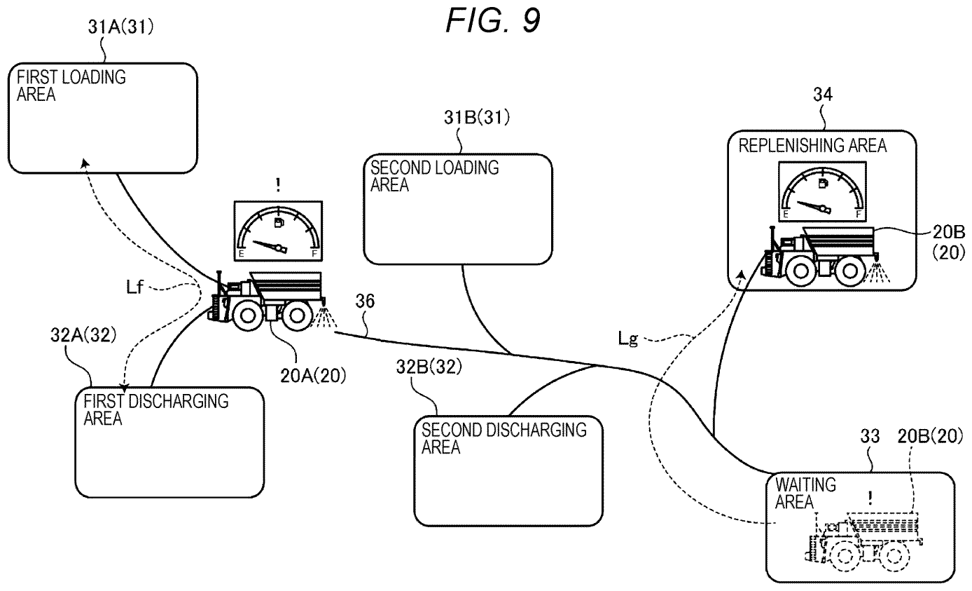

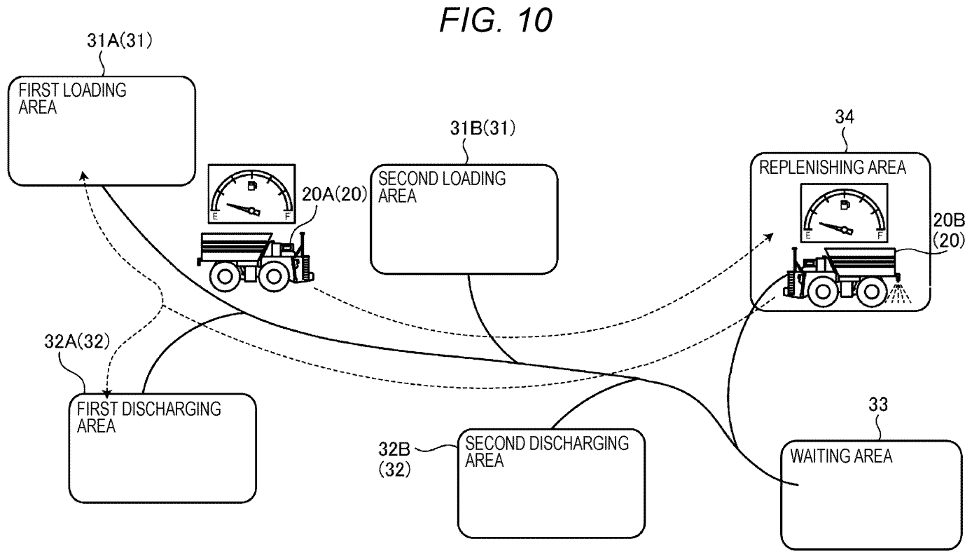

Each of FIGS. 9 and 10 is a schematic diagram illustrating the management method for the unmanned sprinkling vehicle 20 according to the embodiment. There is a case where the unmanned sprinkling vehicle 20 travels from, for example, the waiting area 33 toward the first loading area 31A (first sprinkling area) while sprinkling water using the sprinkling spray 28. When the unmanned sprinkling vehicle 20 travels while sprinkling water using the sprinkling spray 28, water stored in the tank 24 is sprinkled and the water in the tank 24 is consumed. If sufficient water is stored in the tank 24, the unmanned sprinkling vehicle 20 can continue sprinkling water while traveling to the first loading area 31A.

If the amount of water stored in the tank 24 is small, the unmanned sprinkling vehicle 20 may have difficulty in continuing sprinkling water while traveling to the first loading area 31A. The remaining amount monitoring unit 63 monitors the remaining amount of water stored in the tank 24 of the unmanned sprinkling vehicle 20. If the first unmanned sprinkling vehicle 20A (first unmanned vehicle) and the second unmanned sprinkling vehicle 20B (second unmanned vehicle) are present at the work site, the remaining amount monitoring unit 63 monitors a first remaining amount indicating the remaining amount of water stored in the tank 24 of the first unmanned sprinkling vehicle 20A and a second remaining amount indicating the remaining amount of water stored in the tank 24 included in the second unmanned sprinkling vehicle 20B. In a case where the first unmanned sprinkling vehicle 20A is traveling toward the first loading area 31A (first destination), if it is determined that an assignment change condition is satisfied that the first remaining amount indicating the remaining amount of the water stored in the tank 24 of the first unmanned sprinkling vehicle 20A is equal to or less than a predetermined threshold, the second remaining amount indicating the remaining amount of the water stored in the tank 24 of the second unmanned sprinkling vehicle 20B exceeds the first remaining amount, and sufficient water for the second unmanned sprinkling vehicle 20B to travel toward the first loading area 31A is stored, the assignment unit 64 outputs a travel command to the second unmanned sprinkling vehicle 20B so that the second unmanned sprinkling vehicle 20B travels toward the first loading area 31A (first destination, first sprinkling area).

Furthermore, if it is determined that the assignment change condition is satisfied, the assignment unit 64 outputs a travel command to the first unmanned sprinkling vehicle 20A so that the first unmanned sprinkling vehicle 20A travels toward the second loading area 31B (second destination, second sprinkling area) closer to the first unmanned sprinkling vehicle 20A than the first loading area 31A (first destination, first sprinkling area). Note that, if it is determined that the assignment change condition is satisfied, the assignment unit 64 may output a travel command to the first unmanned sprinkling vehicle 20A so that the first unmanned sprinkling vehicle 20A travels toward the replenishing area 34 (second destination) closer to the first unmanned sprinkling vehicle 20A than the first loading area 31A (first destination, first sprinkling area). In the replenishing area 34, water is supplied to the tank 24 of the first unmanned sprinkling vehicle 20A.

That is, if the remaining amount of the water stored in the tank 24 of the first unmanned sprinkling vehicle 20A is small and there is the second unmanned sprinkling vehicle 20B including the tank 24 in which sufficient water is stored, the assignment unit 64 assigns the second unmanned sprinkling vehicle 20B to the first sprinkling area and assigns the first unmanned sprinkling vehicle 20A assigned to the first sprinkling area to the second sprinkling area or the replenishing area 34.

For example, the assignment unit 64 may assign the second unmanned sprinkling vehicle 20B assigned to the second sprinkling area to the first sprinkling area, or may assign the second unmanned sprinkling vehicle 20B waiting in the waiting area 33 to the first sprinkling area. That is, if it is determined that the assignment change condition is satisfied, the assignment unit 64 may output a travel command to the second unmanned sprinkling vehicle 20B so that the second unmanned sprinkling vehicle 20B traveling toward the second sprinkling area (second destination) travels toward the first sprinkling area (first destination), and output a travel command to the first unmanned sprinkling vehicle 20A so that the first unmanned sprinkling vehicle 20A traveling toward the first sprinkling area (first destination) travels toward the second sprinkling area (second destination). That is, if it is determined that the assignment change condition is satisfied, the assignment unit 64 may switch the destination of the first unmanned sprinkling vehicle 20A and the destination of the second unmanned sprinkling vehicle 20B. Furthermore, if it is determined that the assignment change condition is satisfied, the assignment unit 64 may output a travel command to the second unmanned sprinkling vehicle 20B so that the second unmanned sprinkling vehicle 20B waiting in the waiting area 33 travels toward the first sprinkling area (first destination), and output a travel command to the first unmanned sprinkling vehicle 20A so that the first unmanned sprinkling vehicle 20A traveling toward the first sprinkling area (first destination) travels toward the replenishing area 34 (second destination).

In the example illustrated in FIG. 9, the assignment unit 64 outputs a travel command to the first unmanned sprinkling vehicle 20A including the tank 24 so that the first unmanned sprinkling vehicle 20A travels toward the first destination (for example, first loading area 31A) of the work site while sprinkling the water stored in the tank 24 using the sprinkling spray 28. As indicated by an arrow Lf in FIG. 9, the first unmanned sprinkling vehicle 20A travels, for example, toward the first loading area 31A. The remaining amount monitoring unit 63 monitors the first remaining amount indicating the remaining amount of water stored in the tank 24. If it is determined that an assignment change condition is satisfied that the first remaining amount is equal to or less than a predetermined threshold, the assignment unit 64 outputs a travel command to the second unmanned sprinkling vehicle 20B including the tank 24 so that the second unmanned sprinkling vehicle 20B travels toward the replenishing area 34 where the tank 24 is replenished with water. As indicated by an arrow Lg in FIG. 9, for example, the second unmanned sprinkling vehicle 20B waiting in the waiting area 33 travels toward the replenishing area 34.

As illustrated in FIG. 10, the assignment unit 64 outputs a travel command to the second unmanned sprinkling vehicle 20B including the tank 24 replenished with water so that the second unmanned sprinkling vehicle 20B travels toward the first destination (for example, first loading area 31A). Furthermore, if it is determined that the assignment change condition is satisfied, the assignment unit 64 outputs a travel command to the first unmanned sprinkling vehicle 20A so that the first unmanned sprinkling vehicle 20A travels toward the replenishing area 34. In the replenishing area 34, water is supplied to the tank 24 of the first unmanned sprinkling vehicle 20A.

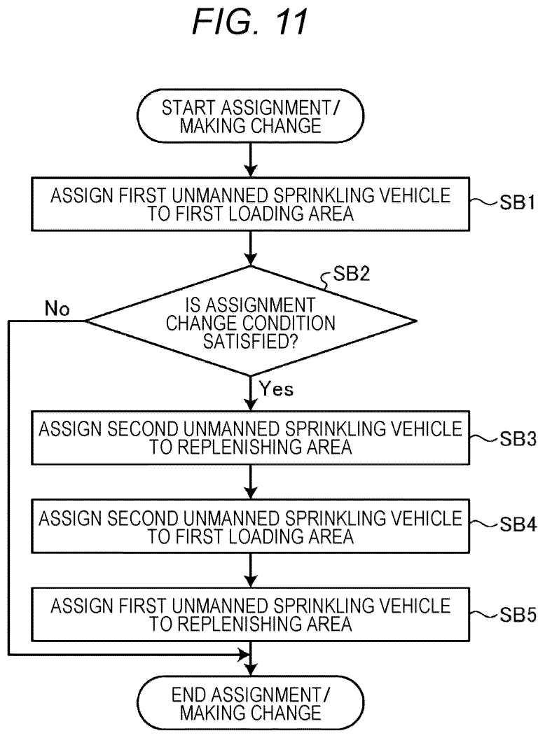

FIG. 11 is a flowchart illustrating the management method for the unmanned sprinkling vehicle 20 according to the embodiment. As a flow start condition, the management device 2 or the administrator of the control facility 4 starts to assign the first unmanned sprinkling vehicle 20A to the first loading area 31A or make a change. The assignment unit 64 assigns the first unmanned sprinkling vehicle 20A to the first loading area 31A as the first sprinkling area (step SB1). The first remaining amount indicating the remaining amount of water stored in the tank 24 of the first unmanned sprinkling vehicle 20A is monitored by the remaining amount monitoring unit 63. The assignment unit 64 determines whether the assignment change condition is satisfied that the first remaining amount is equal to or less than a predetermined threshold (step SB2).

In step SB2, if it is determined that the assignment change condition is satisfied (step SB2: Yes), the assignment unit 64 assigns the second unmanned sprinkling vehicle 20B that exists in the waiting area 33 or the second sprinkling area to the replenishing area 34 (step SB3). In the replenishing area 34, water is supplied to the tank 24 of the second unmanned sprinkling vehicle 20B. After water is supplied to the tank 24 of the second unmanned sprinkling vehicle 20B in the replenishing area 34, the assignment unit 64 assigns the second unmanned sprinkling vehicle 20B including the tank 24 replenished with water to the first loading area 31A (step SB4). The second unmanned sprinkling vehicle 20B travels toward the first loading area 31A while consuming the water in the tank 24. The assignment unit 64 assigns the first unmanned sprinkling vehicle 20A to the replenishing area 34 (step SB5). The destination of the first unmanned sprinkling vehicle 20A is changed from the first loading area 31A to the replenishing area 34. The first unmanned sprinkling vehicle 20A travels toward the replenishing area 34.

As described above, according to the embodiment, the management system 1 for a work site includes the assignment unit 64 that outputs a travel command to the first unmanned transport vehicle 10A including the tank 16 so that the first unmanned transport vehicle 10A travels toward the first destination of the work site while consuming oil that is liquid stored in the tank 16, and the remaining amount monitoring unit 63 that monitors the first remaining amount indicating a remaining amount of oil stored in the tank 16 and the second remaining amount indicating a remaining amount of oil stored in the tank 16 included in the second unmanned transport vehicle 10B. The assignment unit 64 outputs a travel command to the second unmanned transport vehicle 10B so that the second unmanned transport vehicle 10B travels toward the first destination in a case where an assignment change condition is determined to be satisfied that the first remaining amount is equal to or less than a predetermined threshold, the second remaining amount exceeds the first remaining amount, and oil sufficient for the second unmanned transport vehicle 10B to travel toward the first loading area 31A is stored.

Furthermore, the management system 1 for a work site includes the assignment unit 64 that outputs a travel command to the first unmanned sprinkling vehicle 20A including the tank 26 so that the first unmanned sprinkling vehicle 20A travels toward the first destination of the work site while consuming oil that is liquid stored in the tank 26, and the remaining amount monitoring unit 63 that monitors the first remaining amount indicating a remaining amount of oil stored in the tank 26 and the second remaining amount indicating a remaining amount of oil stored in the tank 26 included in the second unmanned sprinkling vehicle 20B. The assignment unit 64 outputs a travel command to the second unmanned sprinkling vehicle 20B so that the second unmanned sprinkling vehicle 20B travels toward the first destination in a case where an assignment change condition is determined to be satisfied that the first remaining amount is equal to or less than a predetermined threshold, the second remaining amount exceeds the first remaining amount, and oil sufficient for the second unmanned sprinkling vehicle 20B to travel toward the first loading area 31A is stored.

According to the embodiment, for example, even if oil is about to run out before the first unmanned transport vehicle 10A arrives at the first destination, the second unmanned transport vehicle 10B travels toward the first destination, so that the work purpose of the unmanned transport vehicle 10 is achieved. As the work purpose of the unmanned transport vehicle 10, a loading work purpose or a discharging work purpose is exemplified. Since the work purpose of the unmanned transport vehicle 10 is achieved, a decrease in productivity at the work site is reduced. This similarly applies to the unmanned sprinkling vehicle 20. As a work purpose of the unmanned sprinkling vehicle 20, a sprinkling work purpose is exemplified. Since the work purpose of the unmanned transport vehicle 10 is achieved, a decrease in productivity at the work site is reduced.

Furthermore, the management system 1 for a work site includes the assignment unit 64 that outputs a travel command to the first unmanned sprinkling vehicle 20A including the tank 24 so that the first unmanned sprinkling vehicle 20A travels toward the first destination of the work site while consuming water that is liquid stored in the tank 24, and the remaining amount monitoring unit 63 that monitors the first remaining amount indicating a remaining amount of water stored in the tank 24 and the second remaining amount indicating a remaining amount of water stored in the tank 24 included in the second unmanned sprinkling vehicle 20B. The assignment unit 64 outputs a travel command to the second unmanned sprinkling vehicle 20B so that the second unmanned sprinkling vehicle 20B travels toward the first destination in a case where an assignment change condition is determined to be satisfied that the first remaining amount is equal to or less than a predetermined threshold and the second remaining amount exceeds the first remaining amount.

According to the embodiment, for example, even if water is about to run out before the first unmanned sprinkling vehicle 20A arrives at the first destination, the second unmanned sprinkling vehicle 20B travels toward the first destination, so that the work purpose of the unmanned sprinkling vehicle 20 is achieved. As a work purpose of the unmanned sprinkling vehicle 20, a sprinkling work purpose is exemplified. Since the work purpose of the unmanned sprinkling vehicle 20 is achieved, a decrease in productivity at the work site is reduced.

1. A management system for a work site, comprising:
a processing circuit configured to
output a travel command to a first unmanned vehicle including a first tank so that the first unmanned vehicle travels toward a first destination of the work site while consuming liquid stored in the first tank,
monitor a first remaining amount indicating a remaining amount of liquid stored in the first tank and a second remaining amount indicating a remaining amount of liquid stored in a second tank included in a second unmanned vehicle, and
output a travel command to the second unmanned vehicle so that the second unmanned vehicle travels toward the first destination in a case in which an assignment change condition is determined to be satisfied that the first remaining amount is equal to or less than a predetermined threshold and oil sufficient for the second remaining amount to travel toward the first destination is stored.

2. The management system for a work site according to claim 1, wherein
each of the first unmanned vehicle and the second unmanned vehicle includes an engine that generates a driving force for traveling,
the liquid is oil that is fuel of the engine, and
consuming the liquid includes burning oil in the engine.

3. The management system for a work site according to claim 2, wherein
the processing circuit is configured to output a travel command to the first unmanned vehicle so that the first unmanned vehicle travels toward a second destination closer to the first unmanned vehicle than the first destination in a case in which the assignment change condition is determined to be satisfied.

4. The management system for a work site according to claim 3, wherein
each of the first unmanned vehicle and the second unmanned vehicle is an unmanned transport vehicle,
the first destination is a first loading area where loading work is performed, and
the second destination is a second loading area where loading work is performed.

5. The management system for a work site according to claim 3, wherein
each of the first unmanned vehicle and the second unmanned vehicle is an unmanned transport vehicle,
the first destination is a first loading area where loading work is performed, and
the second destination is a replenishing area where the first tank is replenished with oil.

6. The management system for a work site according to claim 3, wherein
each of the first unmanned vehicle and the second unmanned vehicle is an unmanned sprinkling vehicle,
the first destination is a first sprinkling area where sprinkling work is performed, and
the second destination is a second sprinkling area where sprinkling work is performed.

7. The management system for a work site according to claim 3, wherein
each of the first unmanned vehicle and the second unmanned vehicle is an unmanned sprinkling vehicle,
the first destination is a first sprinkling area where sprinkling work is performed, and the second destination is a replenishing area where the first tank is replenished with oil.

8. The management system for a work site according to claim 4, wherein
the processing circuit is configured to output a travel command to the second unmanned vehicle so that the second unmanned vehicle traveling toward the second destination travels toward the first destination in a case in which the assignment change condition is determined to be satisfied.

9. The management system for a work site according to claim 4, wherein
the processing circuit is configured to output a travel command to the second unmanned vehicle so that the second unmanned vehicle waiting in a waiting area travels toward the first destination in a case in which the assignment change condition is determined to be satisfied.

10. The management system for a work site according to claim 1, wherein
each of the first unmanned vehicle and the second unmanned vehicle is an unmanned sprinkling vehicle,
the liquid is water to be sprinkled, and
consuming the liquid including sprinkling water.

11. The management system for a work site according to claim 10, wherein
the processing circuit is configured to output a travel command to the first unmanned vehicle so that the first unmanned vehicle travels toward a second destination closer to the first unmanned vehicle than the first destination in a case in which the assignment change condition is determined to be satisfied.

12. The management system for a work site according to claim 11, wherein
the first destination is a first sprinkling area where sprinkling work is performed, and
the second destination is a second sprinkling area where sprinkling work is performed.

13. The management system for a work site according to claim 11, wherein
the first destination is a first loading area where sprinkling work is performed, and
the second destination is a replenishing area where the first tank is replenished with water.

14. The management system for a work site according to claim 12, wherein
the processing circuit is configured to output a travel command to the second unmanned vehicle so that the second unmanned vehicle traveling toward the second destination travels toward the first destination in a case in which the assignment change condition is determined to be satisfied.

15. The management system for a work site according to claim 12, wherein
the processing circuit is configured to output a travel command to the second unmanned vehicle so that the second unmanned vehicle waiting in a waiting area travels toward the first destination in a case in which the assignment change condition is determined to be satisfied.

16. A management system for a work site, comprising:
a processing circuit configured to
output a travel command to a first unmanned sprinkling vehicle including a first tank so that the first unmanned sprinkling vehicle travels toward a first destination of the work site while sprinkling water stored in the first tank,
monitor a first remaining amount indicating a remaining amount of water stored in the first tank, and
output a travel command to a second unmanned sprinkling vehicle including a second tank so that the second unmanned sprinkling vehicle travels toward a replenishing area where the second tank is replenished with water in a case in which an assignment change condition is determined to be satisfied that the first remaining amount is equal to or less than a predetermined threshold.

17. The management system for a work site according to claim 16, wherein
the processing circuit is configured to output a travel command to the second unmanned sprinkling vehicle including the second tank replenished with water so that the second unmanned sprinkling vehicle travels toward the first destination.

18. The management system for a work site according to claim 17, wherein
the processing circuit is configured to output a travel command to the first unmanned sprinkling vehicle so that the first unmanned sprinkling vehicle travels toward the replenishing area in a case in which the assignment change condition is determined to be satisfied.

19. A management method for a work site, comprising:
outputting a travel command to a first unmanned vehicle including a first tank so that the first unmanned vehicle travels toward a first destination of the work site while consuming liquid stored in the first tank;
monitoring a first remaining amount indicating a remaining amount of liquid stored in the first tank and a second remaining amount indicating a remaining amount of liquid stored in a second tank included in a second unmanned vehicle; and
outputting a travel command to the second unmanned vehicle so that the second unmanned vehicle travels toward the first destination in a case in which an assignment change condition is determined to be satisfied that the first remaining amount is equal to or less than a predetermined threshold and the second remaining amount exceeds the first remaining amount.

20. A management method for a work site, comprising:
outputting a travel command to a first unmanned sprinkling vehicle including a first tank so that the first unmanned sprinkling vehicle travels toward a first destination of the work site while sprinkling water stored in the first tank;
monitoring a first remaining amount indicating a remaining amount of water stored in the first tank; and
outputting a travel command to a second unmanned sprinkling vehicle including a second tank so that the second unmanned sprinkling vehicle travels toward a replenishing area where the second tank is replenished with water in a case in which an assignment change condition is determined to be satisfied that the first remaining amount is equal to or less than a predetermined threshold.
